(19) United States
(12) Patent Application Publication
(10) Pub. No.: US 2017/0097057 A1
(43) Pub. Date: Apr. 6, 2017

(54) BRAKE PAD WTH SPRING CLIP FOR NOISE AND VIBRATION ABATEMENT

(71) Applicant: PERFORMANCE FRICTION CORPORATION, Clover, SC (US)

(72) Inventor: Donald L. Burgoon, Gastonia, NC (US)

(21) Appl. No.: 15/282,807

(22) Filed: Sep. 30, 2016

Related U.S. Application Data
(60) Provisional application No. 62/236,089, filed on Oct. 1, 2015.

(51) Int. Cl. F16D 65/097; F16D 65/00

(52) U.S. Cl. CPC F16D 65/0978; F16D 65/0006; F16D 55/226

(57) ABSTRACT

A disc brake pad system. The disc brake pad system includes a brake pad comprising a friction material layer and a brake pad plate for supporting the friction material layer, the brake pad plate including at least one extended portion extending beyond the outer periphery of the friction material layer, the at least one extended portion having a having a hole for positioning an abutment pin therethrough; and a brake pad spring clip for placing within the hole of the brake pad plate about the abutment pin to isolate brake noise and vibrations. A method of abating brake noise and vibration in a disc brake system is also provided.

### RELATED APPLICATION

This application claims priority to U.S. Provisional Application No. 62/236,089, filed on Oct. 1, 2015, the contents of which are hereby incorporated by reference in their entirety.

### FIELD

Disclosed herein is a brake pad system for noise and vibration abatement.

### BACKGROUND

Most conventional motor vehicles are equipped with a brake system for selectively slowing or stopping movement of the vehicle in a controlled manner. Modern automotive braking systems may be grouped into two basic categories, disc brakes and drum brakes. A typical brake system may include a disc brake assembly for each of the front wheels and either a drum brake assembly or a disc brake assembly for each of the rear wheels. Regardless of type, brake assemblies are normally actuated by hydraulic, pneumatic, or mechanical pressure generated by an operator of the vehicle by, for example, depressing a foot pedal, pulling a hand lever, or the like.

The primary components of a conventional disc brake assembly are the rotor or disc, caliper, one or more pistons, and two or more brake pads. The brake pads have a frictional lining supported by a rigid backing plate. The rotor is typically mounted so as to rotate with the axle of the wheel to be braked, configured to transmit braking forces from the caliper assembly to the wheel.

The caliper assembly, which houses the friction pads and pistons, is either solidly attached (fixed-type) or slidably mounted (floating-type) to a stationary, non-rotatable component of the vehicle, such as the vehicle frame. The disc brake piston, traditionally having a circular transverse cross-section, is slidably received in a cylinder bore of the caliper such that the centerline of the piston is parallel to the axis of rotation of the rotor. Through the application of pressure, whether it is hydraulic, mechanical, or pneumatic, the piston is forced to translate and, in so doing, urge the brake pads against a braking surface of the disc rotor, to thereby oppose and restrain rotational movement of the disc rotor through mechanical friction.

During a braking application, the brake pad and rotor may vibrate and generate a high-pitched brake noise, referred to in the art as “brake squeal”. For example, when the friction material of the brake pad contacts the rotor of a brake assembly unevenly, the coupling causes the pad and rotor to oscillate and vibrate, which is also referred to as “force-coupled excitation”. Additionally, as the brake assembly components heat up, the rotor may develop hot spots. The hot spots can cause the rotor to have regions of varying depth and friction, producing inconsistent levels of brake torque, and potentially exacerbating the aforementioned brake squeal.

Brake squeal and vibrations are generally unappealing and unpleasant to vehicle occupants, pedestrians, etc., especially as vehicles are designed to be more comfortable and quieter. Hence, vehicle noise, vibration and harshness (NVH) is an important priority for today's original equipment vehicle manufacturers (OEM).

Efforts have been made to remedy or at least alleviate brake squeal and vibrations. Some simple techniques like beveling or chamfering the linings, greasing the contact portion between the caliper and the linings, increasing the density of the backing plate, etc. help reduce squeal. Another approach to reducing or preventing “brake squeal” is to use a brake pad shim, which is interposed between the piston and backing plate of the brake pad in order to attenuate or reduce the magnitude of vibrations (resonance instability) of the brake pad and the disc rotor.

Brake shims control noise and vibrations in three primary ways. First, they prevent and reduce the transmission and amplitude of vibrational forces that cause excitation of the caliper, pad assembly, and attached structure. This is traditionally accomplished by a viscoelastic damping material within the layering construction of the shims and/or through the bonding of the shim to the pad assembly. Second, shims add mass, even if minimally, to the brake linings which, in turn, dampens vibrations and oscillations by reducing reaction forces transmitted back into the brake piston using elastomer interface coatings on their surface. Finally, the brake shim can act as a thermal barrier to ensure consistent temperatures across the entire face of the pad, minimizing rotor hot spots and uneven lining wear, and providing a more uniform brake torque.

However, despite recent advances, there remains an unmet need in the art to provide brake designs for noise and vibration abatement and to improve the cost, performance and reliability thereof.

### SUMMARY

In one aspect, provided is a disc brake pad system. The disc brake pad system includes a brake pad comprising a friction material layer and a brake pad plate for supporting the friction material layer, the brake pad plate including at least one extended portion extending beyond the outer periphery of the friction material layer, the at least one extended portion having a having a hole for positioning an abutment pin therethrough; and a brake pad spring clip for placing within the hole of the brake pad plate about the abutment pin to isolate brake noise and vibrations.

In some embodiments, the friction material layer is a composite comprising metallic components, organic components, ceramic components, or mixtures thereof.

In some embodiments, the brake pad spring clip comprises a unitary clip.

In some embodiments, the brake pad spring clip comprises a first portion and a second portion.

In some embodiments, the brake pad spring clip comprises a metal spring, a rubber damper, or combinations thereof.

In some embodiments, the brake pad spring clip comprises a material effective to isolate brake pad noise and vibration from a caliper.

In some embodiments, the brake pad system is structured and arranged to permit the brake pad float on the abutment pin.

In some embodiments, the brake pad spring clip is structured and arranged to preload the brake pad to allow push/pull, pull/push or any combination thereof for torque take out.

In some embodiments, the brake pad spring clip is structured and arranged to provide pad retraction to reduce system drag.

In some embodiments, the brake pad system is structured and arranged to provide rattle resistance, without additional brake drag.

In another aspect, provided is a method of abating brake noise and vibration in a disc brake system. The method includes the steps of installing a brake pad comprising a friction material layer and a brake pad plate for supporting the friction material layer, the brake pad plate including at least one extended portion extending beyond the outer periphery of the friction material layer, the at least one extended portion having a having a hole for positioning an abutment pin therethrough; and installing a brake pad spring clip within the hole of the brake pad plate about the abutment pin.

In some embodiments, the friction material layer is a composite comprising metallic components, organic components, ceramic components, or mixtures thereof.

In some embodiments, the brake pad spring clip comprises a unitary clip.

In some embodiments, the brake pad spring clip comprises a first portion and a second portion.

In some embodiments, the brake pad spring clip comprises a metal spring, a rubber damper, or combinations thereof.

In some embodiments, the brake pad spring clip comprises a material effective to isolate brake pad noise and vibration from a caliper.

In some embodiments, the brake pad system is structured and arranged to permit the brake pad float on the abutment pin.

In some embodiments, the brake pad spring clip is structured and arranged to preload the brake pad to allow push/pull, pull/push or any combination thereof for torque take out.

In some embodiments, the brake pad spring clip is structured and arranged to provide pad retraction to reduce system drag.

In some embodiments, the brake pad system is structured and arranged to provide rattle resistance, without additional brake drag.

Other features and advantages of the present invention will appear from the following description in which the preferred embodiments have been set forth in detail in conjunction with the accompanying drawings.

### BRIEF DESCRIPTION OF THE DRAWINGS

Notwithstanding any other forms that may fall within its scope, one preferred form of the invention will now be described by way of example only with reference to the accompanying drawings. Throughout the drawings identical structures are identified by identical reference numerals.

FIG. 1 is a perspective view of a first example of a disc brake assembly to which the present invention may be applied.

FIG. 2 is a partially cutaway view of a second example of a disc brake assembly to which the invention may be applied, as seen from a radially outward position.

FIG. 3 is a portion of a disc brake pad system, according to the present invention.

### DETAILED DESCRIPTION

### Terminology

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise. For example, the phrases “a device,” “an assembly,” “a mechanism,” “a component,” and “an element,” as used herein, may also refer to, and encompass, a plurality of devices, a plurality of assemblies, a plurality of mechanisms, a plurality of components, and a plurality of elements, respectively.

Each of the following terms: “includes,” “including,” “has,” “having,” “comprises,” and “comprising,” and, their linguistic or grammatical variants, derivatives, and/or conjugates, as used herein, means “including, but not limited to.”

About: As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

Above/below: In the following description of the representative embodiments of the invention, directional terms, such as “above”, “below”, “upper”, “lower”, etc., are used for convenience in referring to the accompanying drawings. In general, “above”, “upper”, “upward” and similar terms refer to a direction toward the earth's surface along a wellbore, and “below”, “lower”, “downward” and similar terms refer to a direction away from the earth's surface along the wellbore. Continuing with the example of relative directions in a wellbore, “upper” and “lower” may also refer to relative positions along the longitudinal dimension of a wellbore rather than relative to the surface, such as in describing both vertical and horizontal wells.

Adapted and configured: As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

And/or: The term “and/or” placed between a first entity and a second entity means one of (1) the first entity, (2) the second entity, and (3) the first entity and the second entity. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements). As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of”.

Any: The adjective “any” means one, some, or all indiscriminately of whatever quantity.

At least: As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements). The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Based on: “Based on” does not mean “based only on”, unless expressly specified otherwise. In other words, the phrase “based on” describes both “based only on,” “based at least on,” and “based at least in part on.”

Couple: Any use of any form of the terms “connect”, “engage”, “couple”, “attach”, or any other term describing an interaction between elements is not meant to limit the interaction to direct interaction between the elements and may also include indirect interaction between the elements described.

Determining: “Determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

Embodiments (Forms): Reference throughout the specification to “one embodiment,” “an embodiment,” “some embodiments,” “one aspect,” “an aspect,” “some aspects,” “some implementations,” “one implementation,” “an implementation,” or similar construction means that a particular component, feature, structure, method, or characteristic described in connection with the embodiment, aspect, or implementation is included in at least one embodiment and/or implementation of the claimed subject matter. Thus, the appearance of the phrases “in one embodiment” or “in an embodiment” or “in some embodiments” (or “aspects” or “implementations”) in various places throughout the specification are not necessarily all referring to the same embodiment and/or implementation. Furthermore, the particular features, structures, methods, or characteristics may be combined in any suitable manner in one or more embodiments or implementations.

Exemplary: “Exemplary” is used exclusively herein to mean “serving as an example, instance, or illustration.” Any embodiment described herein as “exemplary” is not necessarily to be construed as preferred or advantageous over other embodiments.

May: Note that the word “may” is used throughout this application in a permissive sense (i.e., having the potential to, being able to), not a mandatory sense (i.e., must).

Operatively connected and/or coupled: Operatively connected and/or coupled means directly or indirectly connected for transmitting or conducting information, force, energy, or matter.

Optimizing: The terms “optimal,” “optimizing,” “optimize,” “optimality,” “optimization” (as well as derivatives and other forms of those terms and linguistically related words and phrases), as used herein, are not intended to be limiting in the sense of requiring the present invention to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the scope of the present invention, are more general. The terms may describe one or more of: 1) working towards a solution which may be the best available solution, a preferred solution, or a solution that offers a specific benefit within a range of constraints; 2) continually improving; 3) refining; 4) searching for a high point or a maximum for an objective; 5) processing to reduce a penalty function; 6) seeking to maximize one or more factors in light of competing and/or cooperative interests in maximizing, minimizing, or otherwise controlling one or more other factors, etc.

Order of steps: It should also be understood that, unless clearly indicated to the contrary, in any methods claimed herein that include more than one step or act, the order of the steps or acts of the method is not necessarily limited to the order in which the steps or acts of the method are recited.

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein.

Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

It is to be understood that the various forms disclosed herein are not limited in their application to the details of the order or sequence, and number, of steps or procedures, and sub-steps or sub-procedures, of operation or implementation of forms of the method or to the details of type, composition, construction, arrangement, order and number of the system, system sub-units, devices, assemblies, sub-assemblies, mechanisms, structures, components, elements, and configurations, and, peripheral equipment, utilities, accessories, and materials of forms of the system, set forth in the following illustrative description, accompanying drawings, and examples, unless otherwise specifically stated herein. The apparatus, systems and methods disclosed herein can be practiced or implemented according to various other alternative forms and in various other alternative ways.

It is also to be understood that all technical and scientific words, terms, and/or phrases, used herein throughout the present disclosure have either the identical or similar meaning as commonly understood by one of ordinary skill in the art, unless otherwise specifically defined or stated herein. Phraseology, terminology, and, notation, employed herein throughout the present disclosure are for the purpose of description and should not be regarded as limiting.

### Description

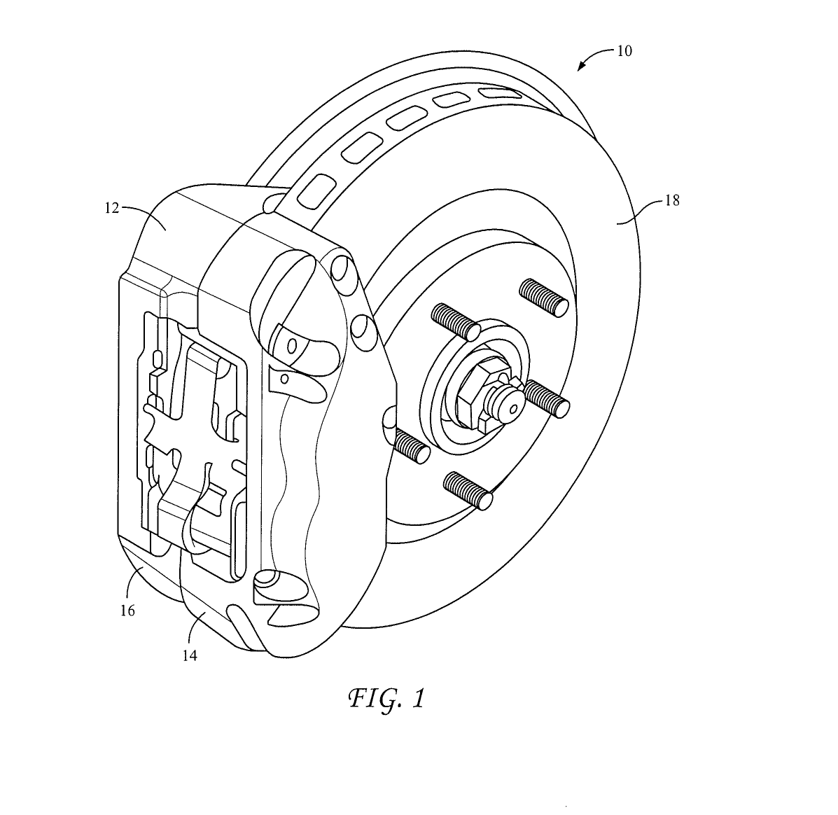

In FIGS. 1-3, like numerals denote like, or similar, structures and/or features; and each of the illustrated structures and/or features may not be discussed in detail herein with reference to the figures. Similarly, each structure and/or feature may not be explicitly labeled in the figures; and any structure and/or feature that is discussed herein with reference to the figures may be utilized with any other structure and/or feature without departing from the scope of the present disclosure.

In general, structures and/or features that are, or are likely to be, included in a given embodiment are indicated in solid lines in the figures, while optional structures and/or features are indicated in broken lines. However, a given embodiment is not required to include all structures and/or features that are illustrated in solid lines therein, and any suitable number of such structures and/or features may be omitted from a given embodiment without departing from the scope of the present disclosure.

FIGS. 1-3 provide illustrative, non-exclusive examples of assemblies, systems and methods for abating noise and vibration from disc brake systems, according to the present disclosure, together with elements that may include, be associated with, be operatively attached to, and/or utilize such assemblies, systems and methods.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled.

The disclosures of all articles and references, including patent applications and publications, are incorporated by reference for all purposes. Other combinations are also possible as will be gleaned from the following claims, which are also hereby incorporated by reference info this written description.

The present disclosure includes a brake system. The brake system may be any type of brake system that may be used to create friction. The brake system may be a disc brake system and include a caliper, a support bracket, and a rotor. The caliper may include a piston bore with a piston, one or more fingers, and a bridge connecting the piston bore to the one or more fingers. The support bracket may include brake pads, pins, or both (e.g., slide pins for the caliper, the brake pads, or both slide upon). However, the brake pads may slide directly on the support bracket. In another example, the brake pads may slide indirectly on a support bracket (i.e., a pad clip may be located between the support bracket and the respective brake pad). The support bracket may include an abutment area. The abutment area may be located adjacent to and may contact a portion of a brake pad, a pad clip, or both.

During a brake application, the piston may be moved into contact with a brake pad and then the brake pad may be moved into contact with the rotor. The caliper may slide so that the one or more fingers move the opposing brake pad into contact with the rotor so that a friction force is created. The piston, the one or more fingers, or both may contact the brake pads in a contact region. The piston, the one or more fingers, or both may contact a shim, in a contact region that is located, between the brake pad and the piston and/or the one or more fingers. The piston, the one or more fingers, or both may contact a brake pad in a contact region.

A perspective view of an opposed-piston type disc brake system 10 is shown in FIG. 1. As shown, a caliper 12 having an outer body 14 and an inner body 16 is provided in a position where the outer body 14 and the inner body 16 hold a rotor 18 therebetween. An outer piston and an inner piston are fitted in an outer cylinder and an inner cylinder, respectively, in an oil-tight fashion so as to be displaced in an axial direction. An outer pad and an inner pad are held in the outer body 14 and the inner body 16, respectively, so as to be displaced individually in the axial direction. When the brakes are applied, hydraulic oil is sent into the outer cylinder and the inner cylinder under pressure, so that the outer pad and the inner pad are pressed against inner and outer side surfaces of the rotor 18 by the outer piston and the inner piston.

When referred to in this specification and claims, axial direction, circumferential direction and radial direction denote axial direction, circumferential direction and radial in relation to a rotor in such a state that a disc brake pad is incorporated in the disc brake assembly, respectively, unless otherwise described. Further, a rotor entrance side denotes a side where the rotor which rotates together with a wheel enters the caliper 12, and a rotor exit side of the caliper 12 denotes a side where the rotor exits from the caliper 12.

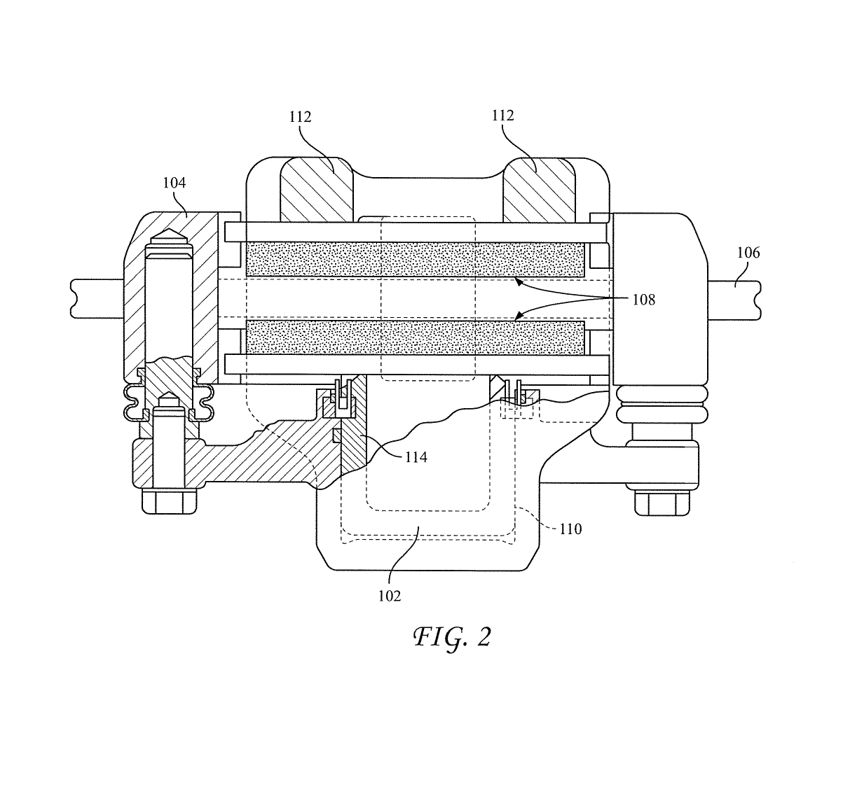

In the floating caliper disc brake system 100 shown in FIG. 2, a caliper 102 is supported at supports 104, which are provided so as to lie adjacent to one side of a rotor 106 in such a way as to be displaced in an axial direction. Additionally, a pair of pads 108, which are disposed on axial sides of the rotor 106, are also supported at the supports 104, so as to be displaced in the axial direction. A cylinder portion 110 and caliper claws 112 are provided on the caliper 102 so as to hold both the pads 108 therebetween from both axial sides.

Of these caliper portions, a piston 114 is incorporated in the cylinder portion 110 so as to press the inner pad 108 (which is situated nearer to a middle of the vehicle in a widthwise direction in such a state that the caliper 102 is assembled to the vehicle, that is, the lower pad in FIG. 2) against the rotor 106.

When applying the brakes, oil is sent into the cylinder portion 110 under pressure, so that the inner pad 108 is pressed against an inner side surface of the rotor 106, from bottom to top in FIG. 2, by the piston 114. Then, the caliper 102 is displaced downwards in FIG. 2, as a reaction to the pressing force exerted on the pad 108 by the piston 114, whereby the caliper claws 112 press the outer pad 108 (which is situated outwards of the vehicle in the widthwise direction in such a state that the caliper 102 is assembled to the vehicle, that is, the upper pad in FIG. 2) against the outward side surface of the rotor 106. As a result of this, the rotor 106 is strongly held on the inner and outer side surfaces thereof by the pads 108, thus applying the brake.

With the opposed piston-type disc brake assembly shown in FIG. 1 and the floating caliper-type disc brake assembly shown in FIG. 2, it is known that the pads are made unstable when the brakes are applied, thereby causing vibrations and abnormal noise called brake squeal.

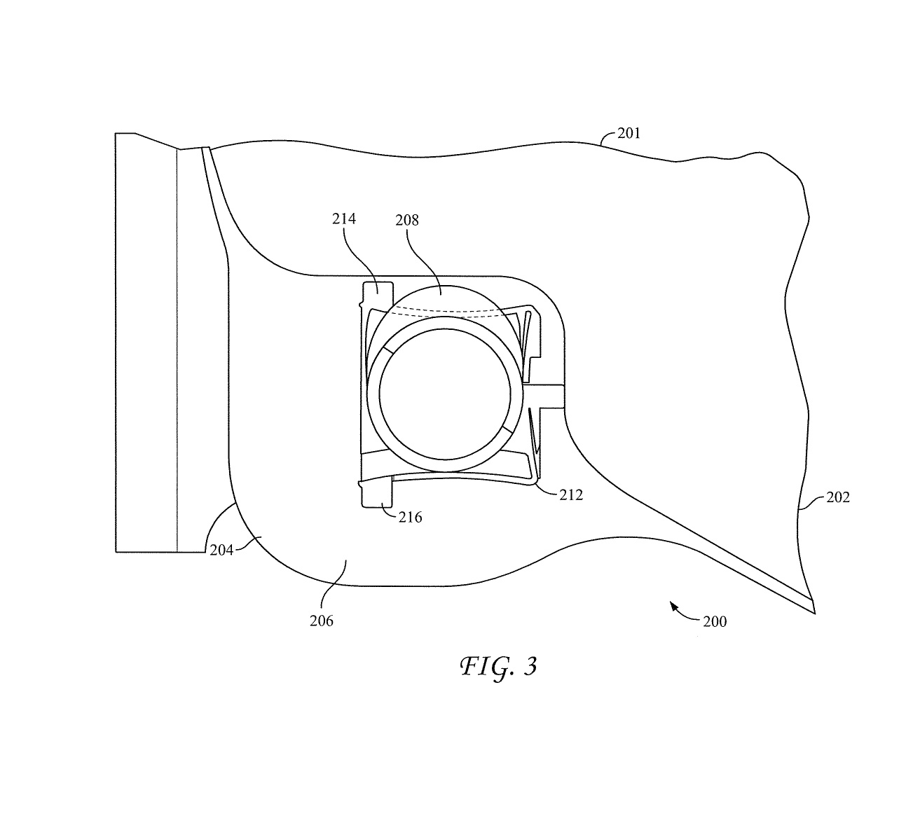

As will be described hereinbelow, the incorporation of the disc brake pad system of the present disclosure addresses the issue of excessive noise and vibration. Referring now to FIG. 3 a portion of a disc brake pad system 200, according to the present disclosure is shown. Disc brake pad system 200 includes a brake pad 201, brake pad 201 comprising a friction material layer 202. The friction material layer 202 may be a composite material comprising metallic components, organic components, ceramic components or mixtures thereof.

Disc brake pad 201 also includes a brake pad plate 204 for supporting the friction material layer 202. As shown, the brake pad plate 204 includes at least one extended portion 206 extending beyond the outer periphery of the friction material layer 202. The at least one extended portion 206 includes a hole 208 for positioning an abutment pin 210 therethrough.

Disc brake pad system 200 further includes a brake pad spring clip 212 for placing within the hole 208 of the brake pad plate 204 about the abutment pin 210. Brake pad spring clip 212 may be a unitary clip, or may include a first portion 214 and a second portion 216, as shown. Brake pad spring clip 212 may comprise a metal spring, a rubber damper, combinations thereof, or any material effective to isolate brake pad noise and vibration from a caliper.

The design of brake pad system 200 and its brake pad spring clip 212 permits the brake pad 201 to “float” on the abutment pins 210. In some embodiments, the spring clip 212 can also preload the brake pad 201 to allow push/pull, pull/push or any combination for torque take out, as may be appreciated by those skilled in the art.

In some embodiments, brake pad system 200 can also be used to provide pad retraction to reduce system drag.

The brake pad system disclosed herein provides built-in noise and rattle resistance, without the additional drag of other systems. The use of a spring clip or damper inside the disc brake pad plate serves to isolate the noise and vibrations inherent in current brake systems.

The brake pads disclosed herein may be manufactured by a variety of industry recognized methods. One method having utility is disclosed in U.S. Pat. No. 5,141,083 to Burgoon, the contents of which are hereby incorporated by reference for those details.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

Further illustrative, non-exclusive examples of assemblies and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

PCT1. A disc brake pad system comprising: a brake pad comprising a friction material layer and a brake pad plate for supporting the friction material layer, the brake pad plate including at least one extended portion extending beyond the outer periphery of the friction material layer, the at least one extended portion having a having a hole for positioning an abutment pin therethrough; and a brake pad spring clip for placing within the hole of the brake pad plate about the abutment pin to isolate brake noise and vibrations.

PCT2. The system of paragraph PCT1, wherein the friction material layer is a composite comprising metallic components, organic components, ceramic components, or mixtures thereof.

PCT3. The system of paragraphs PCT1 or PCT2, wherein the brake pad spring clip comprises a unitary clip.

PCT4. The system of paragraphs PCT1-PCT3, wherein the brake pad spring clip comprises a first portion and a second portion.

PCT5. The system of paragraphs PCT1-PCT4, wherein the brake pad spring clip comprises a metal spring, a rubber damper, or combinations thereof.

PCT6. The system of paragraphs PCT1-PCT5, wherein the brake pad spring clip comprises a material effective to isolate brake pad noise and vibration from a caliper.

PCT7. The system of paragraphs PCT1-PCT6, wherein the brake pad system is structured and arranged to permit the brake pad float on the abutment pin.

PCT8. The system of paragraphs PCT1-PCT7, wherein the brake pad spring clip is structured and arranged to preload the brake pad to allow push/pull, pull/push or any combination thereof for torque take out.

PCT9. The system of paragraphs PCT1-PCT8, wherein the brake pad spring clip is structured and arranged to provide pad retraction to reduce system drag.

PCT10. The system of paragraphs PCT1-PCT9, wherein the brake pad system is structured and arranged to provide rattle resistance, without additional brake drag.

PCT11. A method of abating brake noise and vibration in a disc brake system, comprising: installing a brake pad comprising a friction material layer and a brake pad plate for supporting the friction material layer, the brake pad plate including at least one extended portion extending beyond the outer periphery of the friction material layer, the at least one extended portion having a having a hole for positioning an abutment pin therethrough; and installing a brake pad spring clip within the hole of the brake pad plate about the abutment pin.

PCT 12. The method of paragraph PCT11, wherein the friction material layer is a composite comprising metallic components, organic components, ceramic components, or mixtures thereof.

PCT 13. The method of paragraphs PCT11 or PCT12, wherein the brake pad spring clip comprises a unitary clip.

PCT 14. The method of paragraphs PCT11-PCT13, wherein the brake pad spring clip comprises a first portion and a second portion.

PCT 15. The method of paragraphs PCT11-PCT14, wherein the brake pad spring clip comprises a metal spring, a rubber damper, or combinations thereof.

PCT 16. The method of paragraphs PCT11-PCT15, wherein the brake pad spring clip comprises a material effective to isolate brake pad noise and vibration from a caliper.

PCT 17. The method of paragraphs PCT11-PCT16, wherein the brake pad system is structured and arranged to permit the brake pad float on the abutment pin.

PCT 18. The method of paragraphs PCT11-PCT17, wherein the brake pad spring clip is structured and arranged to preload the brake pad to allow push/pull, pull/push or any combination thereof for torque take out.

PCT 19. The method of paragraphs PCT11-PCT18, wherein the brake pad spring clip is structured and arranged to provide pad retraction to reduce system drag.

PCT 20. The method of paragraphs PCT11-PCT19, wherein the brake pad system is structured and arranged to provide rattle resistance, without additional brake drag.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A disc brake pad system comprising:
a brake pad comprising a friction material layer and a brake pad plate for supporting the friction material layer, the brake pad plate including at least one extended portion extending beyond the outer periphery of the friction material layer, the at least one extended portion having a having a hole for positioning an abutment pin therethrough; and
a brake pad spring clip for placing within the hole of the brake pad plate about the abutment pin to isolate brake noise and vibrations.

2. The system of claim 1, wherein the friction material layer is a composite comprising metallic components, organic components, ceramic components, or mixtures thereof.

3. The system of claim 1, wherein the brake pad spring clip comprises a unitary clip.

4. The system of claim 1, wherein the brake pad spring clip comprises a first portion and a second portion.

5. The system of claim 1, wherein the brake pad spring clip comprises a metal spring, a rubber damper, or combinations thereof.

6. The system of claim 1, wherein the brake pad spring clip comprises a material effective to isolate brake pad noise and vibration from a caliper.

7. The system of claim 1, wherein the brake pad system is structured and arranged to permit the brake pad float on the abutment pin.

8. The system of claim 1, wherein the brake pad spring clip is structured and arranged to preload the brake pad to allow push/pull, pull/push or any combination thereof for torque take out.

9. The system of claim 1, wherein the brake pad spring clip is structured and arranged to provide pad retraction to reduce system drag.

10. The system of claim 1, wherein the brake pad system is structured and arranged to provide rattle resistance, without additional brake drag.

11. A method of abating brake noise and vibration in a disc brake system, comprising:
installing a brake pad comprising a friction material layer and a brake pad plate for supporting the friction material layer, the brake pad plate including at least one extended portion extending beyond the outer periphery of the friction material layer, the at least one extended portion having a having a hole for positioning an abutment pin therethrough; and
installing a brake pad spring clip within the hole of the brake pad plate about the abutment pin.

12. The method of claim 11, wherein the friction material layer is a composite comprising metallic components, organic components, ceramic components, or mixtures thereof.

13. The method of claim 11, wherein the brake pad spring clip comprises a unitary clip.

14. The method of claim 11, wherein the brake pad spring clip comprises a first portion and a second portion.

15. The method of claim 11, wherein the brake pad spring clip comprises a metal spring, a rubber damper, or combinations thereof.

16. The method of claim 11, wherein the brake pad spring clip comprises a material effective to isolate brake pad noise and vibration from a caliper.

17. The method of claim 11, wherein the brake pad system is structured and arranged to permit the brake pad float on the abutment pin.

18. The method of claim 11, wherein the brake pad spring clip is structured and arranged to preload the brake pad to allow push/pull, pull/push or any combination thereof for torque take out.

19. The method of claim 11, wherein the brake pad spring clip is structured and arranged to provide pad retraction to reduce system drag.

20. The method of claim 11, wherein the brake pad system is structured and arranged to provide rattle resistance, without additional brake drag.
